(19) United States
(12) Patent Application Publication
(10) Pub. No.: US 2024/0202042 A1
(43) Pub. Date: Jun. 20, 2024

(54) CLOUD APPLICATION RESOURCE UTILIZATION TOOL

(71) Applicant: Tangoe US, Inc., Stamford, CT (US)

(72) Inventors: Paolo Sellari, Shelton, CT (US); Dawn Michele Preston, Cleveland, GA (US); Jaan Leemet, Aventura, FL (US)

(21) Appl. No.: 18/542,073

(22) Filed: Dec. 15, 2023

Related U.S. Application Data
(60) Provisional application No. 63/432,902, filed on Dec. 15, 2022.

(51) Int. Cl. G06F 9/50; G06F 9/451

(52) U.S. Cl. CPC G06F 9/5055; G06F 9/451

(57) ABSTRACT

A system and method are proposed that allows for predictive analysis to model Information Technology costs, such as hosting costs, in various scenarios, such as, reducing/expanding workforce, shutting locations, or adding locations. The system, in performing optimization functions, gathers data from various locations and providers and normalizes the data in data structures to allow for direct comparison of costs with calculated data needs, which allows for automatic optimization of the organization's Information Technology resources.

### FIELD OF THE INVENTION

The following relates to predictive data modelling of data usage for cloud applications, particularly the ability to estimate resource usage with various operational scenarios. The system derives estimated cloud resource utilization and costing from hypothetical models such that these predictions can be used to aid with operational planning and to configure selected settings in the hosting environment or target systems.

### BACKGROUND OF THE INVENTION

Companies may go through operational changes frequently as they adjust and adapt to the market environment. In some cases, expansion and contraction may be cyclical, while in other cases operational changes may occur as a reaction to changing market or economic conditions.

Depending on the industry, companies may implement a variety of operational changes to remain within budget or to achieve performance metrics based on costs and profitability.

When faced with having to make significant reductions, companies may undergo staff reductions, or even more drastic changes, such as reducing the size of, or closing sites altogether in order to adhere to operational budgets.

Alternatively, when in a growth mode, companies may consider opening new sites, expanding existing sites, or moving into larger locations as well as onboarding additional staff.

Such expansion and contraction activities have clear implications in terms of salaries and leases, but there are also operational costs such as Information Technology (“IT”) costs that include accounting for what is needed in the way of computing resources and software licenses in order to support these locations and staff whether they are being reduced or increased.

More particularly, operational costs such as cloud-based computing and hosted services are increasingly prevalent with the availability of cloud-based software and these can comprise a substantial part of operational costs. These must be factored into any scenario planning and into business forecasting.

Estimating these costs is rarely a simple matter of tallying up resource use per individual, or per application. Usage may fall into tiers of users, needed features may only be available with higher-end software licenses, and cloud providers may have minimum or maximum thresholds on resource allocations or configurations. In some cases, in particular with staff reductions, users may be asked to take on additional tasks. These expanded roles may require additional licenses or additional computing resources.

Further, when expanding internationally, privacy laws may force the use of local cloud instances requiring local cloud providers, which may bring about a variety of migration costs. Security measures specific to a site may also have to be implemented, some of which may have to be tailored to the offerings of the local cloud provider. Product licenses that are shared in one country may not be applicable internationally and may require new subscriptions. Subscriptions from country to country may even follow a completely different pricing models altogether. Even when performing expansion or contraction activities in a familiar location, license models may have caps on users, may be site specific, and have restrictions in how they can be applied.

Even in the simplest case of adding existing licenses and buying additional throughput and processing power for users, a tool that can provide operational cost estimates for various scenarios would be beneficial to aid in planning.

Further, a tool that can assess application specific operational costs, and cloud provider costs allowing for the analysis of cloud migrations would also be beneficial. This can include both moving new services into the cloud or moving services from one cloud provider to another.

U.S. Pat. No. 9,529,689 entitled Monitoring Cloud Computing Environments, provides a method for tracking utilization in cloud environments, such that processes that have been initiated can be monitored and so that the system can determine which are running properly. This system does not, however, address the licensing aspects of software, or the scaling factors associated with many of the changing scenarios described herein or the geographical implications of international expansion.

U.S. patent application Ser. No. 15/989,276 (now U.S. Pat. No. 10,552,223 issued Feb. 4, 2020) entitled User interface and system supporting user decision making and readjustments in computer-executable job allocations in the cloud describes a user interface tool that can explore different job configurations. It uses a sandbox to allow users to manipulate job parameters to see how jobs are affected in terms of compute time. While this application allows some hypothetical scenarios for specific jobs, it does not consider elements such as license costs or geographic locations and impact these have due to operational changes. Further, the configuration options are rudimentary requiring a deep knowledge of the computing environment.

Neither of the above referenced systems utilize actual company resource usage data to run operational change impacts to derive costs associated with the changes.

Additionally, neither of the above referenced systems employs any type of automated machine learning for analysis and forecasting of models from actual company resource usage.

It would thus be beneficial to have a system and method that can estimate and/or calculate the delta costs and compare possible scenarios considering hosting requirements and costs as well as license requirements and costs factoring in geographical regions, availability and pricing models.

It would be further beneficial to have a system and method that can factor in the complex variables involved in calculating these hypothetical operational scenarios providing cost estimates for resource usage of such tools.

It would be further beneficial to have the system and method that can provision and perform the configuration changes necessary or initiate (or decommission) the computing requirements needed for the estimated expansion or contraction activities that have been modeled, (i.e., implement the modeled hypothetical scenario).

### SUMMARY OF THE INVENTION

It is therefore an object of the present invention to provide a system and method for estimating the resource utilization in cloud applications associated with different operational planning scenarios.

It is further desired to provide a system and method that utilizes machine learning to automatically generate an ideal IT plan based on operational changes that accounts for hosting and license requirements taking into consideration geographic regions, roles, resource availability, and pricing models relevant to the operational changes.

The system is able to provide cost estimates taking into consideration expected complexity to provide time frames and/or effort estimates of such projects.

While the system and method may be principally used for planning and estimating changes to the cloud computing environment to match operational scenarios, the knowledge contained in the system relating to the associated hosting providers, plans and location specific requirements allows the system to automatically configure or commission the changes required and put the modeled scenarios into place.

The term “data” as used herein means any indicia, signals, marks, symbols, domains, symbol sets, representations, and any other physical form or forms representing information, whether permanent or temporary, whether visible, audible, acoustic, electric, magnetic, electromagnetic, or otherwise manifested. The term “data” as used to represent predetermined information in one physical form shall be deemed to encompass any and all representations of the same predetermined information in a different physical form or forms.

The term “network” as used herein includes both networks and internetworks of all kinds, including the Internet, and is not limited to any particular network or inter-network.

The terms “first” and “second” are used to distinguish one element, set, data, object, or thing from another, and are not used to designate relative position or arrangement in time unless otherwise stated.

To model a company's existing resource use, a system is provided that includes a set of robotic software programs running on one or more computers and a cloud-based software program collecting resource utilization data related to the running of one or more applications within the organizations environment.

In one embodiment, the system collects resource utilization statistics and details from alerts received from the hosting provider upon which the application is running. The system further models the resource utilization as it may affect the hosting cost of the application. Such resource use includes but is not limited to CPU utilization, bandwidth usage, memory, and disk usage.

In another embodiment, the system relies on application self-monitoring through built-in functions in the app to automatically report and control resource usage behavior over time.

In yet another embodiment, the system uses a wrapper/container in which the app runs, which acts as an intermediary for resource requests. The container/wrapper is an application itself where the target application being monitored runs. In such a configuration, whenever the target application makes a resource request, the request is intercepted by the wrapper and is then redirected to the system for the actual resource allocation. The wrapper is thus able to measure and monitor these resource requests as well as provide control functions, such as, granting or denying the requests, or delaying or deferring or even altering and/or modifying the requests. The wrappers can optimize resource utilization of a system and in this context provide the necessary inputs for measuring and monitoring resource utilization of the target app. When used in conjunction with the knowledge or geographical and user data, this resource usage can be correlated to users, roles, locations, and functions.

In one configuration a system and method are provided to collect data and observe patterns of data usage over time. The system generates models of resource usage for the company, which are stored as tables over time and can be represented in graphs to show the ebb and flow of resource utilization highlighting peaks and valleys in usage. As a simple example, resource utilization peaks over office hours and can be identified when people are using the system. Conversely, usage would likely taper off, perhaps to nothing, as people leave for the day. Of course, background processes, people dialing in from remote locations, and customers ordering products om-line would continue to use some level of resources in a more realistic case.

As a continued example, end of month may entail sales reporting, and accounting functions that take more resources and create a peak in the resource utilization near the last working days of a given month. The system keeps a minimum and maximum value with a typical range over time in a table, which can be graphed to represent the typical usage. When utilization for a given day, such as a Sunday, is examined, the system will capture utilization every 15 minutes that can be saved in a table as individual time entries. This time period can be adjusted for finer or coarser granularity. The table also allows for keeping a total account of usage, a minimum and a maximum (i.e., valley and peak usage), as well as an average usage value. Aside from total, the last month and last year's values are also kept allowing for the system to learn of trending patterns as they emerge. Such trends may be affected by company expansion or contraction but may also be related to changing roles, changed to way roles are performed or changes to software programs or the addition or new software or obsolescence of old software being used on the system.

The resource utilization data is stored in a model as described above. The predicted resource usage over time is also generated taking into consideration outside factors such as the number of users and number of sites. When these change, additional variables may be used to highlight the parameters of the system. For example, while above we describe a table of values for resource utilization over time, it may be advantageous to generate and save a complementary table showing the addition of sites with timestamps of when these changes occurred. This allows the system to accurately predict utilization increases when adding a site for the organization. When models are run whereby additional sites are added, the learned values from actual newly added sites are used. The system is able to detect new locations and geographic zones through public IPs and through hosing facilities, and administrators are able to confirm or enter these manually to configure the systems as well.

When these variables do change, the system also employs machine learning to capture the resource utilization changes and costs associated with these changes so that it can better predict and model proposed changes.

In another embodiment, the system is connected to available hosting systems and can obtain the parameters of the then current plans and configuration options, including geographically based options, such that the modeling can accurately forecast usage in terms of expected cost. The usage data, and predicted usage data can be overlayed with the available plans and options to forecast the predicted cost within the context of a given hosting provider. In cases where modeling is done that involves substantial changes to resource utilization, the system or tool also considers these potential plan changes and hosting provider changes. It should be noted that the system can automatically perform this optimization as well as performing the modeling

In yet another configuration a system and method are provided allowing users to model possible future resource utilization based on adjusting a hypothetical number of users or sites. In such scenarios, the system uses the historical data it has collected, knowledge of current plans and resources available, in conjunction with machine learning to model resources and subsequent costs in the hypothetical scenario.

In one specific example, consider a scenario where a company has 10 sites with 100 people in each site. The system has been modeling resource utilization over time and to simplify the example, imagine that each of the 10 sites uses the same number of resources. To further simplify the example, all 10 of the sites have the same hosting provider with the same hosting costs available to them.

Using the modeling system proposed, the company's analyst inputs a possible scenario where they will shut down one of the 10 locations and let all 100 people at the given site go. No duplication or additional resources will be imposed on the remaining staff from these departures. The modeling system can predict and generate the cost savings in resource use from these changes. Having access and knowledge of the business related data, such as sales per geographic location and per site, the system can also model the resulting business impact from the changes. The analyst considers the potential impact on sales and the potential loss of customers in that location and reconsiders making such a change, instead, the analyst then decides to model cutting the number of employees in ½ instead to measure the impact. Alternatively, the analyst may also run additional scenarios such as cutting 10 people from each location to reach the targeted 100 person reduction, or cutting 20 people from the 5 worst performing locations for example. In each case, the system models the costs and the business implications helping the analyst come up with various solutions based on the desired outcome. Through the use of machine learning and artificial intelligence, the system can also propose the most cost effective changes that it estimates to have the lowest impact to the business or the greatest overall savings. This can be done through both an analysis of and projection of many hypothetical models as well as historical data from actual savings. In a system with a large historical database, it may even take these predictions to the individual site, group, or even user level based on past and predicted performance.

In certain aspects a hosted resource utilization predictor is provided by software executing on a computer, said software accessing a storage containing usage information, the usage information indicative of usage of computing resources by a software application. The usage information correlates one or more activity based indicators with one or more portions of the usage of the computing resources. The software provides a user interface allowing a user to indicate one or more activity changes for the software application and the software, based on the one or more activity changes accesses the storage to determine a correlation indicative which activity based indicators are correlated with the one or more activity changes. Based on the determined correlation between the activity based indicators and the one or more activity changes, said software determining a corresponding predicted change in usage of the computing resources. The software accesses one or more service level agreements associated with a provider of the computing resources to determine how the predicted change in usage of the computing resources impacts a cost of usage of the computing resources which are associated with the service level agreement and the software providing the cost to the user. The software also accesses business and human resources data to measure and correlate company performance data and individual performance data in the context of resource utilization and company performance where such correlations can be made, such as sales individuals and overall company sales.

In certain aspects the activity changes are indicative of a change in staff personnel associated with a company utilizing the software application. In other aspects the activity changes are indicative of a change in staff personnel associated with a company utilizing the software application. In still other aspects the software measures an actual change in usage compared to the user indicated one or more activity changes and based on the actual change in usage, said software determines an actual prediction of change in usage and compares the actual prediction of change in usage to an actual change in usage in order to update how activity based indictors are correlated with the one or more activity changes. In yet other aspects the software reserves or activates one or more computing resources based on the predicted change in usage of the computing resources. In still other aspects the software releases or de-activates one or more computing resources based on the predicted change in usage of the computing resources. In yet other aspects the one or more activity changes indicated by the user are selected from the group consisting of: addition of one or more locations, addition of one or more countries of operation, addition or removal of one or more employees with access to the software application, modification of types of employees with access to the software application, the roles of such employees, and combinations thereof. In yet other aspects the one or more activity changes indicated by the user are indicative of a sale, promotion or special event.

Other objects are achieved by providing computer implemented method of predicting hosted resource utilization comprising one or more of the steps of: providing software executing on a computer, said software accessing a storage containing usage information, the usage information indicative of usage of computing resources by a software application, wherein the usage information correlates one or more activity based indicators with one or more portions of the usage of the computing resources; providing a user interface allowing a user to indicate one or more activity changes for the software application and the software, based on the one or more activity changes accesses the storage to determine a correlation indicative which activity based indicators are correlated with the one or more activity changes; determining a predicted change in usage of the computing resources with said software, said determining based on the determined correlation between the activity based indicators and the one or more activity changes; accessing one or more service level agreements with said software, said one or more service level agreements associated with a provider of the computing resources to determine how the predicted change in usage of the computing resources impacts a cost of usage of the computing resources which are associated with the service level agreement and the software providing the cost to the user.

In certain aspects the activity changes are indicative of a change in staff personnel associated with a company utilizing the software application. In other aspects the activity changes are indicative of a change in staff personnel associated with a company utilizing the software application. In still other aspects the software measures an actual change in usage compared to the user indicated one or more activity changes and based on the actual change in usage, said software determines an actual prediction of change in usage and compares the actual prediction of change in usage to an actual change in usage in order to update how activity based indictors are correlated with the one or more activity changes. In still other aspects the software reserves or activates one or more computing resources based on the predicted change in usage of the computing resources. In yet other aspects, the software releases or de-activates one or more computing resources based on the predicted change in usage of the computing resources. In still other aspects the one or more activity changes indicated by the user are selected from the group consisting of: addition of one or more locations, addition of one or more countries of operation, addition or removal of one or more employees with access to the software application, modification of types of employees with access to the software application and combinations thereof. In yet other aspects the one or more activity changes indicated by the user are indicative of a sale, promotion or special event.

Other objects are achieved by providing a hosted resource utilization predictor including software executing on a computer, said software accessing a storage containing usage information, the usage information indicative of usage of computing resources by a software application. The usage information correlates one or more activity based indicators with one or more portions of the usage of the computing resources. The software provides a user interface allowing a user to indicate one or more activity changes for the software application and the software, based on the one or more activity changes accesses the storage to determine a correlation indicative which activity based indicators are correlated with the one or more activity changes. Based on the determined correlation between the activity based indicators and the one or more activity changes, said software determining a corresponding predicted change in usage of the computing resources. The software further measures an actual change in usage compared to the user indicated one or more activity changes and based on the actual change in usage, said software determines an actual prediction of change in usage and compares the actual prediction of change in usage to an actual change in usage in order to update how activity based indictors are correlated with the one or more activity changes.

Other objects of the invention and its particular features and advantages will become more apparent from consideration of the following drawings and accompanying detailed description.

### BRIEF DESCRIPTION OF THE DRAWINGS

FIG. 1 is a functional flow diagram according to the present invention.

FIG. 2 shows the resource modeling application (software) of FIG. 1 whereby various scenario models are created.

FIG. 3 shows the resource modeling application implementing the changes to configure a proposed scenario.

FIG. 4 illustrates a GUI for the resource estimation system according to the system of FIG. 1.

FIG. 5 illustrates a resource table according to the system of FIG. 1.

### DETAILED DESCRIPTION OF THE INVENTION

Referring now to the drawings, wherein like reference numerals designate corresponding structure throughout the views. The following examples are presented to further illustrate and explain the present invention and should not be taken as limiting in any regard.

The present invention relates to systems and methods for performing scenario planning for resource utilization in cloud-based software as part of service expense management. RPA (Robotic Process Automation) agents, ETL components, services, and functions are deployed as part of a resource modeling engine to monitor application activities detecting and establishing trends and patterns through resource monitoring. The RPA agents report metrics to the resource modeling engine, which uses machine learning to evolve a learning base of information and keep track of a predictive model for resource utilization and costing.

Administrators can also create scenarios by adjusting variables, such as, the number of people or locations for a business to be used in modeling. Thus, hypothetical models are created by the system estimating the adjusted cost and resource usage. These hypothetical models are stored and can be displayed and adjusted further to evolve the scenarios as desired.

Further, based on the modeling, dynamic adjustments to platform resources can be done so as to implement the scenario being modelled.

The system is thus capable of detecting and predicting resource usage requirements, which can be used to estimate costs in a hypothetical planning capacity.

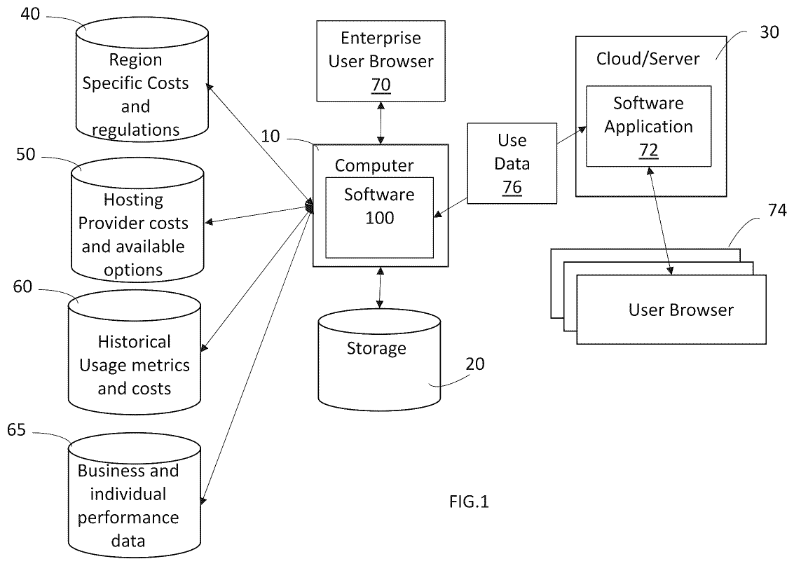

Referring to FIG. 1, the components of a predictive modeling inclusion system are illustrated. A computer 10 is connected to storage 20 and to the cloud 30. The computer includes software 100 executing thereon. This software is also referred to as the resource modeling application. Data from regional costs and regulations 40, from hosting providers 50, and from historical usage metrics 60 are used by the system to perform the modeling. Business and individual performance data 65 are also entered and modeled to weigh the implication of changes in the model. Users access the system from an app or through a browser 70. The storages 40, 50, 60 and 20 may be independent or may be network connected storages or databases or may be all within a single storage. Users of the software application 72 access the software application via e.g. a user browser 74. The software 100 accesses one or more of the storages to obtain usage information which indicates usage of computing resources by the software application 72. The usage information may be real time use data 76 or historical usage data 60 or combinations thereof. The usage information correlates various activities within the software application with usage of computing resources. These activities may be, for example, the usage profile associated with a typical salesperson or someone in a particular role, addition of a new location, new country or various other personnel, operational or other types of changes that impact usage of the software application 72.

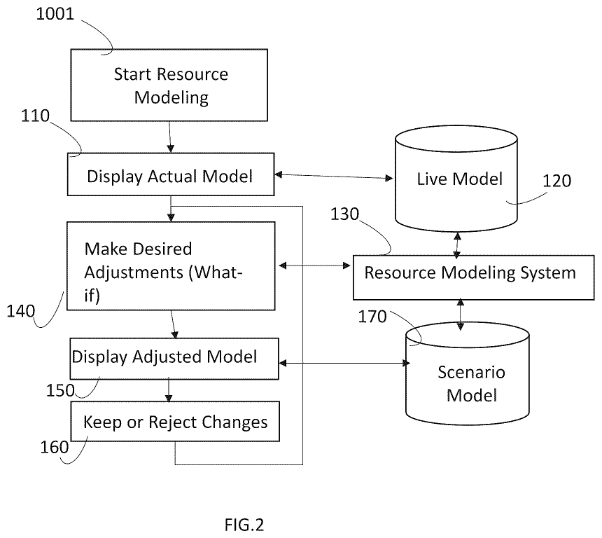

Turning now to FIG. 2, the method by which the system performs modeling is illustrated. The resource modeling application is started 1001 and reads the live model 120 and displays it to the user 110 in terms of costs, number of sites, number of users, including granular details such as licenses, hosting parameters, etc.

The user can adjust 140 the model 120 by changing the parameters shown, and these changes are sent to the resource modeling system 130 (which can be part of the software 100). This resource modeling system 130 in turn creates a scenario model 170. The system displays the adjusted model 150 such that the user can decide to keep or change 160 the parameters based on the outcome. This process may continue 140 with additional adjustments being implemented until a desired outcome or multiple outcomes are achieved to be presented and decided upon.

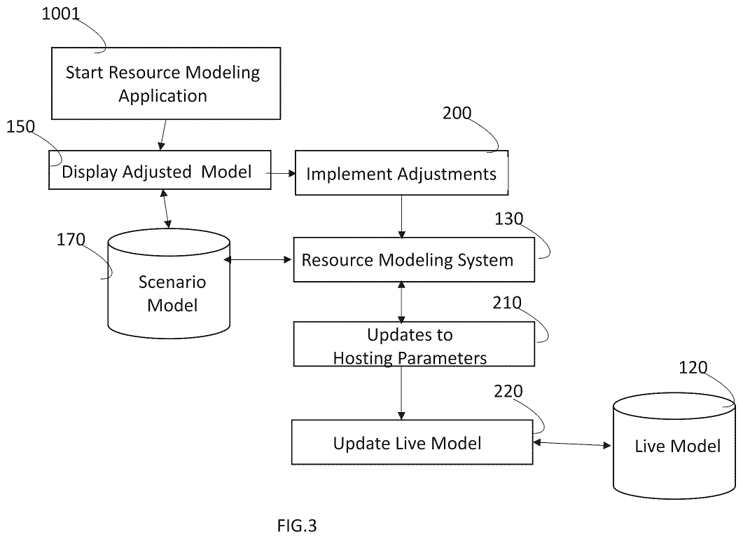

Turning now to FIG. 3, this shows how the changes can be applied and implemented in the hosting system. The resource modeling application 100 displays the adjusted model 150 as shown in FIG. 2. The scenario model 170 is adjusted as necessary until the user decides to implement the changes 200. At that time, the changes made to the scenario model 170 are read by the resource modeling system 100, and the parameters needed to implement these changes are sent to the hosting providers (210). When the changes have been implemented, the live mode 120 is also updated 220. Therefore, based on these activity changes indicated to the software, modeling system can determine how the activity based indicators are expected to result in activity changes within the software application. Once these are determined, the corresponding change in computing resources can be determined by the software.

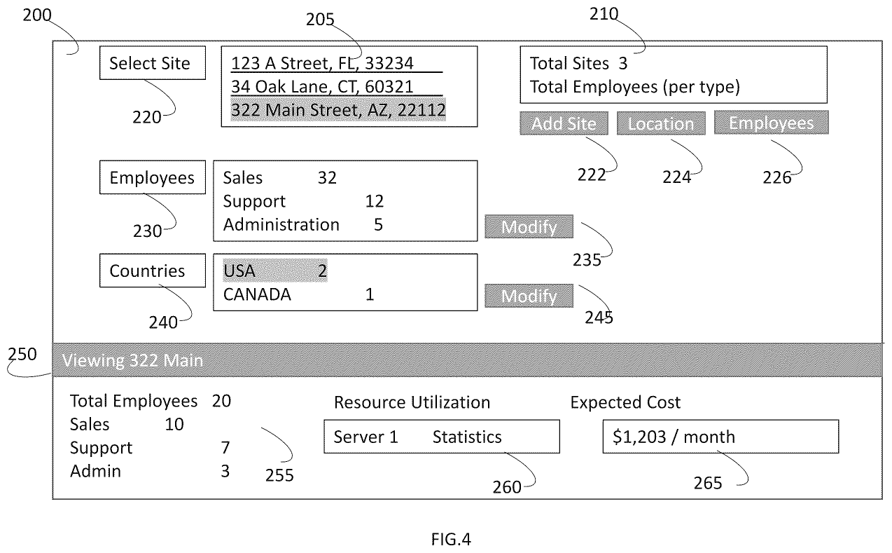

Turning to FIG. 4, one example of a sample GUI for the resource estimation system 200 is presented. A number of sites are shown, which can be selected for modeling 205. Site selection is made by highlighting the site in a panel 205 and activating the select button 220. The statistics for the site selected are shown in summary in a panel 210 and the main viewing window 250, where they are broken down by employee types 255 and resource utilization 260 and expected cost 265. Each of these can be clicked to drill down into detail or to select finer grained parameters.

Additional selections for employees 230 may be provided, where one can select to modify 235 as indicated. Similarly, the selection can be modified by country specific sites, or by selecting the country 240 or adding more countries with the modify button 265. Therefore, the software provides a user interface that allows the user to test how changes in activity in terms of software application use will do to computing resource usage. The changes in activity may be related to e.g. adding a location, country, employees (including different types of employees) as well as events which may drive usage such as sales events, promotions or other situations which are expected to change how an application is used. The software can also implement these changes by reserving or activity various computing resources or by releasing or de-activating resources if appropriate.

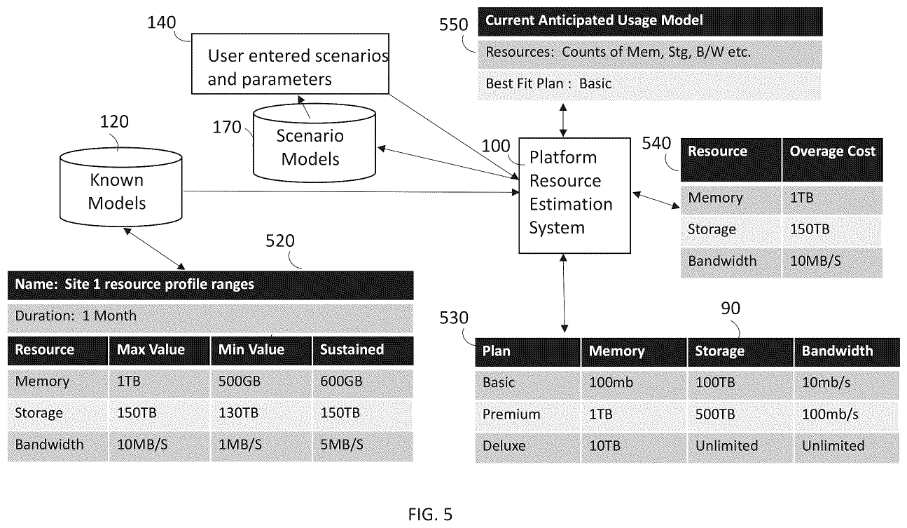

In FIG. 5 a resource table is provided that shows the tabular fashion in which the data is maintained. The user enters scenarios 140, which the platform resource estimation system 100 receives as an input. The system then pulls the known models 120 that are shown in table 520 and the existing plans 90, which are shown in table form in 530, and overage costs should plans be exceeded, which is shown in table 540. The system knows the anticipated resource usage from table 550 derived from the current model and current usage predicted. In applying the user entered scenarios 140, the delta costs are predicted and displayed, and a scenario model created 170, which is displayed to the user 140. The user is allowed to continue changing the parameters as indicated in FIG. 1-3. The system, having access to data corresponding to actual events, can better predict the scenarios entered by the user. As a simple example, the user may decide to add a site location. In this scenario, details about the site are entered (size, location, number of salespeople, etc.). These parameters enable the system to compare past data from similar sites to incrementally add the data to the calculation of estimated usage and subsequent cost estimates. Similarly, if a site is removed in the user scenario, the data from the site collected historically can be removed from the estimated usage and subsequent cost estimate. Thus, the software can access service level agreements for each applicable computing resource provider to determine how the predicted computing usage changes will impact cost and supply that information to the user.

Furthermore, the actual change in usage following a particular activity change can be compared to the predicted change. The actual change in usage is compared to the user indicated activity changes to determine what the prediction should have been based on actual activity changes. The determined prediction based on actual activity changes is then compared to the actual usage changes in order to better determine predictions based on input activity changes. By comparing the indicated activity changes to actual and then running a prediction based on the actual changes, that prediction can be compared to actual change in usage so that a correct and accurate comparison is done. Going forward, predictions are made using the more accurate comparison such that the software learns over time to provide better predictions for user indicated activity changes.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A hosted resource utilization predictor comprising:
software executing on a computer, said software accessing a storage containing usage information, the usage information indicative of usage of computing resources by a software application;
wherein the usage information correlates one or more activity based indicators with one or more portions of the usage of the computing resources;
said software providing a user interface allowing a user to indicate one or more activity changes for the software application and the software, based on the one or more activity changes accesses the storage to determine a correlation indicative which activity based indicators are correlated with the one or more activity changes;
based on the determined correlation between the activity based indicators and the one or more activity changes, said software determining a corresponding predicted change in usage of the computing resources;
said software further accessing one or more service level agreements associated with a provider of the computing resources to determine how the predicted change in usage of the computing resources impacts a cost of usage of the computing resources which are associated with the service level agreement and the software providing the cost to the user.

2. The hosted resource utilization predictor of claim 1 wherein the activity changes are indicative of a change in staff personnel associated with a company utilizing the software application.

3. The hosted resource utilization predictor of claim 1 wherein the activity changes are indicative of a change in staff personnel associated with a company utilizing the software application.

4. The hosted resource utilization predictor of claim 1 wherein the software measures an actual change in usage compared to the user indicated one or more activity changes and based on the actual change in usage, said software determines an actual prediction of change in usage and compares the actual prediction of change in usage to an actual change in usage in order to update how activity based indictors are correlated with the one or more activity changes.

5. The hosted resource utilization predictor of claim 1 wherein said software reserves or activates one or more computing resources based on the predicted change in usage of the computing resources.

6. The hosted resource utilization predictor of claim 1 wherein said software releases or de-activates one or more computing resources based on the predicted change in usage of the computing resources.

7. The hosted resource utilization predictor of claim 1 wherein said one or more activity changes indicated by the user are selected from the group consisting of: addition of one or more locations, addition of one or more countries of operation, addition or removal of one or more employees with access to the software application, modification of types of employees with access to the software application and combinations thereof.

8. The hosted resource utilization predictor of claim 1 wherein said one or more activity changes indicated by the user are indicative of a sale, promotion or special event.

9. A computer implemented method of predicting hosted resource utilization comprising:
providing software executing on a computer, said software accessing a storage containing usage information, the usage information indicative of usage of computing resources by a software application;
wherein the usage information correlates one or more activity based indicators with one or more portions of the usage of the computing resources;
providing a user interface allowing a user to indicate one or more activity changes for the software application and the software, based on the one or more activity changes accesses the storage to determine a correlation indicative which activity based indicators are correlated with the one or more activity changes;
determining a predicted change in usage of the computing resources with said software, said determining based on the determined correlation between the activity based indicators and the one or more activity changes;
accessing one or more service level agreements with said software, said one or more service level agreements associated with a provider of the computing resources to determine how the predicted change in usage of the computing resources impacts a cost of usage of the computing resources which are associated with the service level agreement and the software providing the cost to the user.

10. The method of claim 9 wherein the activity changes are indicative of a change in staff personnel associated with a company utilizing the software application.

11. The method of claim 9 wherein the activity changes are indicative of a change in staff personnel associated with a company utilizing the software application.

12. The hosted resource utilization predictor of claim 9 wherein the software measures an actual change in usage compared to the user indicated one or more activity changes and based on the actual change in usage, said software determines an actual prediction of change in usage and compares the actual prediction of change in usage to an actual change in usage in order to update how activity based indictors are correlated with the one or more activity changes.

13. The hosted resource utilization predictor of claim 9 wherein said software reserves or activates one or more computing resources based on the predicted change in usage of the computing resources.

14. The hosted resource utilization predictor of claim 9 wherein said software releases or de-activates one or more computing resources based on the predicted change in usage of the computing resources.

15. The hosted resource utilization predictor of claim 9 wherein said one or more activity changes indicated by the user are selected from the group consisting of: addition of one or more locations, addition of one or more countries of operation, addition or removal of one or more employees with access to the software application, modification of types of employees with access to the software application and combinations thereof.

16. The hosted resource utilization predictor of claim 9 wherein said one or more activity changes indicated by the user are indicative of a sale, promotion or special event.

17. A hosted resource utilization predictor comprising:
software executing on a computer, said software accessing a storage containing usage information, the usage information indicative of usage of computing resources by a software application;
wherein the usage information correlates one or more activity based indicators with one or more portions of the usage of the computing resources;
said software providing a user interface allowing a user to indicate one or more activity changes for the software application and the software, based on the one or more activity changes accesses the storage to determine a correlation indicative which activity based indicators are correlated with the one or more activity changes;
based on the determined correlation between the activity based indicators and the one or more activity changes, said software determining a corresponding predicted change in usage of the computing resources;
wherein the software measures an actual change in usage compared to the user indicated one or more activity changes and based on the actual change in usage, said software determines an actual prediction of change in usage and compares the actual prediction of change in usage to an actual change in usage in order to update how activity based indictors are correlated with the one or more activity changes.

18. The hosted resource utilization predictor of claim 17 wherein said software further accesses one or more service level agreements associated with a provider of the computing resources to determine how the predicted change in usage of the computing resources impacts a cost of usage of the computing resources which are associated with the service level agreement and the software providing the cost to the user.

19. The hosted resource utilization predictor of claim 17 wherein the activity changes are indicative of a change in staff personnel associated with a company utilizing the software application.

20. The hosted resource utilization predictor of claim 9 wherein said software reserves, activates, releases or de-activates one or more computing resources based on the predicted change in usage of the computing resources.
